(19) United States
(12) Patent Application Publication
(10) Pub. No.: US 2026/0095542 A1
(43) Pub. Date: Apr. 2, 2026

(54) INFORMATION MANAGEMENT APPARATUS, INFORMATION MANAGEMENT METHOD, AND PROGRAM

(71) Applicant: HONDA MOTOR CO., LTD., Tokyo (JP)

(72) Inventors: Yuta Nishizawa, Tokyo (JP); Junichiro Onaka, Tokyo (JP)

(21) Appl. No.: 19/336,535

(22) Filed: Sep. 23, 2025

(30) Foreign Application Priority Data
Sep. 30, 2024 (JP) 2024-169888

(51) Int. Cl. H04N 5/50; G06F 3/01; H04N 5/60

(52) U.S. Cl. CPC H04N 5/50; G06F 3/011; H04N 5/602

(57) ABSTRACT

An information management apparatus according to an embodiment is an information management apparatus that manages information acquired from a first device mounted on a movable body on which an occupant boards and provided to a second device used by a user at a different place from the movable body, the information management apparatus including: an acquisition portion that acquires information from the first device and the second device; and a provision portion that provides information to each second device based on the information acquired by the acquisition portion, wherein the acquisition portion acquires a first sound at a first position of the movable body and a second sound at a second position that is different from the first position by the first device and acquires motion information of the user by the second device, and the provision portion provides the second device with a sound in which the sound volume ratio of the first sound and the second sound is adjusted in accordance with a motion of the user.

### CROSS-REFERENCE TO RELATED APPLICATION

Priority is claimed on Japanese Patent Application No. 2024-169888, filed on Sep. 30, 2024, the contents of which are incorporated herein by reference.

### BACKGROUND

### Field of the Invention

The present invention relates to an information management apparatus, an information management method, and a program.

### Background

In the related art, researches have been conducted on performing communication between a device mounted on a movable body such as a vehicle and a device used at a different place from the movable body and sharing of an image of a vehicle outside landscape or the like. For example, Japanese Unexamined Patent Application, First Publication No. 2016-033764 discloses a technique of outputting information in response to an external factor at the outside of a device.

### SUMMARY

However, in the technique of the related art, although a sound is output in accordance with the distance to a target object that is present in a sight line direction of a user and a state of the target object, information in accordance with a motion of the user is not output. Therefore, there is a problem that a user who is at a different place from the movable body may not sufficiently feel a sense of presence.

An object of the present invention is to provide an information management apparatus, an information management method, and a program that can enhance a sense of presence given to a user who is at a different place from a movable body. The present invention improves the visibility of the user and the safety of an occupant, further improves the safety of the traffic, and contributes to the development of a sustainable transportation system.

An information management apparatus according to a first aspect of the present invention is an information management apparatus that manages information acquired from a first device mounted on a movable body on which an occupant boards and provided to a second device used by a user at a different place from the movable body, the information management apparatus including: an acquisition portion that acquires information from the first device and the second device; and a provision portion that provides information to each second device based on the information acquired by the acquisition portion, wherein the acquisition portion acquires a first sound at a first position of the movable body and a second sound at a second position that is different from the first position by the first device and acquires motion information of the user by the second device, and the provision portion provides the second device with a sound in which the sound volume ratio of the first sound and the second sound is adjusted in accordance with a motion of the user.

A second aspect is the information management apparatus according to the first aspect described above, wherein the first sound may be a sound collected at a room inside of the movable body, the second sound may be a sound collected at a room outside of the movable body, and the provision portion may provide the second device with a sound in which a sound volume of the second sound is smaller than that of the first sound in response to the user being in a first posture corresponding to a posture of being at the room inside of the movable body and may provide the second device with a sound in which the sound volume of the second sound is larger than that of the first sound in response to the user performing a motion of becoming a second posture corresponding to a posture of being at the room outside of the movable body from the first posture.

A third aspect is the information management apparatus according to the second aspect described above, wherein the first posture may be a seated posture, and the second posture may be a standing posture.

A fourth aspect is the information management apparatus according to the second aspect described above, wherein the first posture may be a posture of facing a travel direction of the movable body in a seated state, and the second posture may be a posture of facing a direction that is orthogonal to the travel direction of the movable body in the seated state.

A fifth aspect is the information management apparatus according to the second aspect described above, wherein the first posture may be a posture of seeing a travel direction of the movable body, and the second posture may be a posture of seeing a direction that is orthogonal to the travel direction of the movable body.

A sixth aspect is the information management apparatus according to the first aspect described above, wherein the first sound may be a sound at a room inside of the movable body, the second sound may be a sound at a room outside of the movable body, the provision portion may provide the second device with a sound in which a sound volume of the second sound is smaller than that of the first sound when a window of the movable body is in a closed state, and the provision portion may provide the second device with a sound in which a sound volume of the second sound is larger than that of the first sound in response to the user performing a motion of opening the window of the movable body.

A seventh aspect is the information management apparatus according to the second aspect described above, wherein the acquisition portion may acquire a room inside image and a room outside image of the movable body by the first device, and the provision portion may provide the second device with the room inside image in response to the user being in the first posture and may provide the second device with the room outside image in response to the user performing a motion of becoming the second posture from the first posture.

An eighth aspect is the information management apparatus according to the first aspect described above, wherein the provision portion may provide the second device with an image indicating the sound volume ratio of the first sound and the second sound.

An information management method according to a ninth aspect of the present invention includes: by way of a computer of an information management apparatus that manages information acquired from a first device mounted on a movable body on which an occupant boards and provided to a second device used by a user at a different place from the movable body, acquiring information from the first device and the second device; providing information to each second device based on the acquired information; acquiring a first sound at a first position of the movable body and a second sound at a second position that is different from the first position by the first device; acquiring motion information of the user by the second device; and providing the second device with a sound in which the sound volume ratio of the first sound and the second sound is adjusted in accordance with a motion of the user.

A tenth aspect of the present invention is a computer-readable non-transitory storage medium storing a program which causes a computer of an information management apparatus that manages information acquired from a first device mounted on a movable body on which an occupant boards and provided to a second device used by a user at a different place from the movable body to: acquire information from the first device and the second device; provide information to each second device based on the acquired information; acquire a first sound at a first position of the movable body and a second sound at a second position that is different from the first position by the first device; acquire motion information of the user by the second device; and provide the second device with a sound in which the sound volume ratio of the first sound and the second sound is adjusted in accordance with a motion of the user.

According to the first to tenth aspects described above, it is possible to enhance a sense of presence given to a user who is at a different place from a movable body.

### BRIEF DESCRIPTION OF THE DRAWINGS

FIG. 1 is a view showing a use environment and the like of an information processing system and a management server.

FIG. 2 is a view showing an example of the contents of user data.

FIG. 3 is a configuration view of a first device.

FIG. 4 is a view showing an example of an arrangement of part of the first device in a movable body.

FIG. 5 is a configuration view of a second device.

FIG. 6 is a view showing an image corresponding to a pointing direction.

FIG. 7 is a view showing a first example of a functional configuration of a first control device and a second control device.

FIG. 8 is a view showing a second example of a functional configuration of the first control device and the second control device.

FIG. 9 is a sequence view showing an example of a process performed by the information processing system.

FIG. 10 is a view showing an example of first provision information.

FIG. 11 is a view showing an example of second provision information.

FIG. 12 is a view showing an example of third provision information.

FIG. 13 is a view showing an example of a functional configuration of a management server in a modification example.

### DESCRIPTION OF EMBODIMENTS

Hereinafter, an embodiment of an information management apparatus, an information management method, and a program of the present invention will be described with reference to the drawings. In the following description, an information processing system to which the information management apparatus is applied is described. The information processing system includes, for example, a first device mounted on a movable body on which an occupant boards, a second device used by a user at a different place from the movable body, and the information management apparatus. The movable body is, for example, a vehicle and may be any movable body (for example, a ship or a flying object) as long as an occupant can board on the movable body. Further, the occupant is mainly a driver of the movable body, but may be an occupant other than the driver.

Between the first device and the second device, a sound collected by a microphone is transmitted to a partner side and is reproduced by a speaker, and thereby, a state in which a telephone conversation is performed is established. Here, the sound includes the voice of an occupant collected by a first microphone unit of the first device, a vehicle inside sound of the first device, a vehicle outside sound of the first device, and the voice of a user collected by a second microphone of the second device. Further, between the first device and the second device, part of an image captured by a camera unit of the first device is displayed by the second device. Thereby, MR (Mixed Reality) is provided to a second device side. Accordingly, the user of the second device can obtain a feeling (simulation boarding experience) as if the user is boarding on the movable body in a simulated manner while being at a different place from the movable body, and the occupant can obtain a feeling as if the user is actually and jointly boarding on the movable body by performing a conversation with the user who is performing the simulation experience of boarding on the movable body via the first device. In the following description, as described above, performing a simulation experience as if the user is actually boarding may be referred to as “performing a simulation boarding”. It is not necessary for the first device and the second device to be in a one-to-one relationship, and the information processing system may operate by matching one of a plurality of first devices and a plurality of second devices in a one-to-many relationship. In the latter case, for example, one occupant can communicate with a plurality of users simultaneously or sequentially.

### Basic Configuration

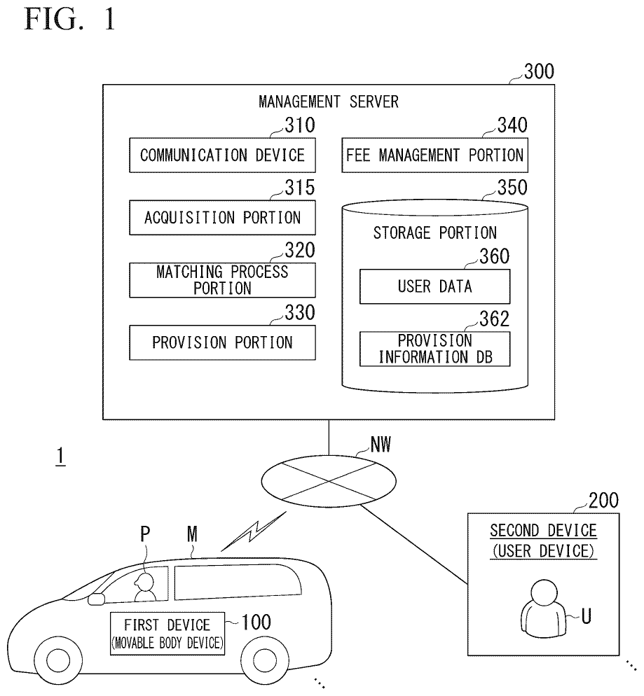

FIG. 1 is a view showing a use environment and the like of an information processing system 1 and a management server 300. The information processing system 1 includes a first device (movable body device) 100 mounted on a movable body M on which an occupant P boards and a second device (user device) 200 used by a user U at a different place from the movable body M (a near place by chance is not excluded). Each of the first device 100, the second device 200, and the management server 300 communicates with each other via a network NW. The information processing system 1 may include the management server 300 or may not include the management server 300. The network NW includes, for example, at least one of the Internet, a WAN (Wide Area Network), a LAN (Local Area Network), a mobile communication network, a cellular network, and the like. The management server 300 is an example of an “information management apparatus”. The management server 300 may be realized by a server device or a storage device incorporated in a cloud computing system.

In this case, the function of the management server 300 may be realized by a plurality of server devices and storage devices in the cloud computing system. Further, the first device 100 mounted on the movable body M may be realized by a plurality of units.

The management server 300 manages information provided to each of the first device 100 and the second device 200 and performs a management for each of the first device 100 and the second device 102 to perform a communication. The management server 300 includes, for example, a communication device 310, an acquisition portion 315, a matching process portion 320, a provision portion 330, a fee management portion 340, and a storage portion 350. The acquisition portion 315, the matching process portion 320, the provision portion 330, and the fee management portion 340 are realized, for example, by a hardware processor such as a CPU (Central Processing Unit) executing a program (software). Part or all of these components may be realized by hardware (a circuit portion; including circuitry) such as an LSI (Large Scale Integration), an ASIC (Application Specific Integrated Circuit), a FPGA (Field-Programmable Gate Array), or a GPU (Graphics Processing Unit), or may be realized by the cooperation of software and hardware. The program may be stored in advance in a storage device (storage device including a non-transitory storage medium) such as an HDD (Hard Disk Drive) or a flash memory, or may be stored in a removable storage medium (non-transitory storage medium) such as a DVD or a CD-ROM and be installed by the storage medium being attached to a drive device. Further, the program may be stored in the management server 300 and be timely updated by being connected to the network NW.

The communication device 310 is a communication interface for the connection to the network NW.

A communication between the communication device 310 and the first device 100 and a communication between the communication device 310 and the second device 200 are performed, for example, in accordance with the TCP/IP (Transmission Control Protocol/Internet Protocol).

The acquisition portion 315 acquires various information transmitted by the first device 100, the second device 200, and another external device via the network NW. The various information may include moving image data, voice data of a driver, and vehicle data (display contents of a meter and an IVI (in-vehicle infotainment) system, or the like).

The matching process portion 320 is realized, for example, by a processor such as a CPU executing a program (command group) stored in the storage medium. For example, when the communication device 310 receives a matching request, for example, from the user U via the second device 200 or from the occupant P via the first device 100, the matching process portion 320 performs matching between a matching user U and the occupant P with reference to user data 360, transmits communication identification information of the first device 100 of the occupant P to the second device 200 of a matched user U by using the communication device 310, and transmits communication identification information of the second device 200 of the user U to the first device 100 of the matched occupant P. Between the first device 100 and the second device 200 that receive these information, it becomes possible to perform a communication having a higher real-time performance, for example, in accordance with the UDP (User Datagram Protocol).

The provision portion 330 generates information provided to each of the first device 100 and the second device 200 based on various information acquired by the acquisition portion 315 and transmits the generated information to a target device. Further, the provision portion 330 generates information indicating a process result by the matching process portion 320, fee information (settlement information) managed by the fee management portion 340, and the like and provides the generated information to the target device.

The fee management portion 340 manages a fee to be charged to the user U in accordance with information provided to the user U and a fee to be charged to the occupant P in accordance with information provided to the occupant P of the movable body M. Further, the fee management portion 340 may manage, for example, the compensation to be paid to the user U or the occupant P in accordance with information provision from the user U or the occupant P. Further, the fee management portion 340 may perform a process relating to the settlement of the user U and the occupant P.

The storage portion 350 may be realized by various storage devices described above, an SSD (Solid State Drive), an EEPROM (Electrically Erasable Programmable Read Only Memory), a ROM (Read Only Memory), a RAM (Random Access Memory), or the like. The storage portion 350 stores, for example, the user data 360, provision information DB 362, a program, and other various information.

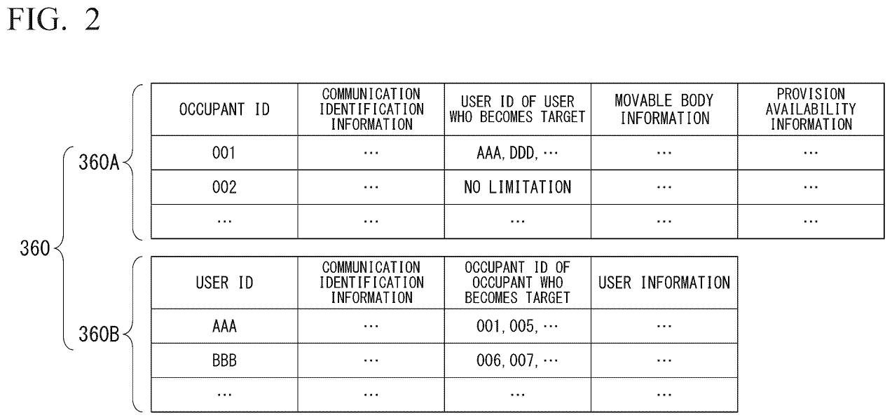

FIG. 2 is a view showing an example of the contents of the user data 360. The user data 360 includes an occupant list 360A and a user list 360B. In the occupant list 360A, for example, an occupant ID which is identification information of an occupant P of a movable body M, communication identification information (an IP address or the like) thereof, a user ID which is identification information of a user U who becomes a matching target, movable body information on which the occupant is boarding, and provision availability information set by the occupant are associated with one another. The movable body information includes, for example, device information (mounted device information) mounted on the movable body M and vehicle constitution information indicating the size and the outer shape of the movable body M. Further, the movable body information may include information relating to a current position, a destination, and a surrounding situation (for example, traveling on a road along the sea) of the movable body M transmitted from the movable body M at a predetermined cycle. In the user list 360B, for example, a user ID, communication identification information (an IP address or the like) thereof, an occupant P who becomes a matching target, and user information are associated with one another. The user information may include information (for example, a body height and a seating height) relating to a body type, information (for example, an age) from which the body type can be predicted, and the like. The provision availability information is information that the movable body M can provide or information that the movable body M cannot provide, and is set, for example, by the occupant P. The provision availability information may be set for each mounted device of the movable body M or may be set for each user U.

Examples of the provision availability information include “provision of an image is permitted”, “provision of a voice is not permitted, but provision of a vehicle inside sound and a vehicle outside sound are permitted”, “provision of a room inside image is permitted, but provision of a room outside image is not permitted”, “provision of an image of an occupant is not permitted”, “use of a navigation device is not permitted”, and the like, but are not limited thereto. Further, the provision availability information may include a fee (service provision fee) for enabling the provision. The user data 360 is not limited to the form shown in FIG. 2 and may be generated in any form as long as the user data 360 includes these information.

The provision information DB 362 stores various information to be provided to the user U or the occupant P. The various information includes, for example, map information, POI (Point Of Interest) information, and an image drawn by a computer process (for example, a CG (Computer Graphics) image of a person or the like and an image of a mark, a symbol, an icon, or the like). The POI information is, for example, information relating to various stores, theme parks, geographic features, and the like of each point, and may be included in the map information. Further, the various information may include sound information. Further, the provision information DB 362 may include advertisement information. The advertisement information may include, for example, an advertisement relating to the movable body M, an advertisement relating to the user U or the occupant P, and an advertisement relating to commercial goods or services of a store. The inserted advertisement information may be managed separately from the information of the room inside and the room outside and the like, and when being archived and distributed later, the information may be different from the inserted advertisement information distributed in real time (for example, a closed store is changed to the latest one, the introduced menu is changed to the latest one, and the like). The advertisement information is, for example, a moving image or a voice.

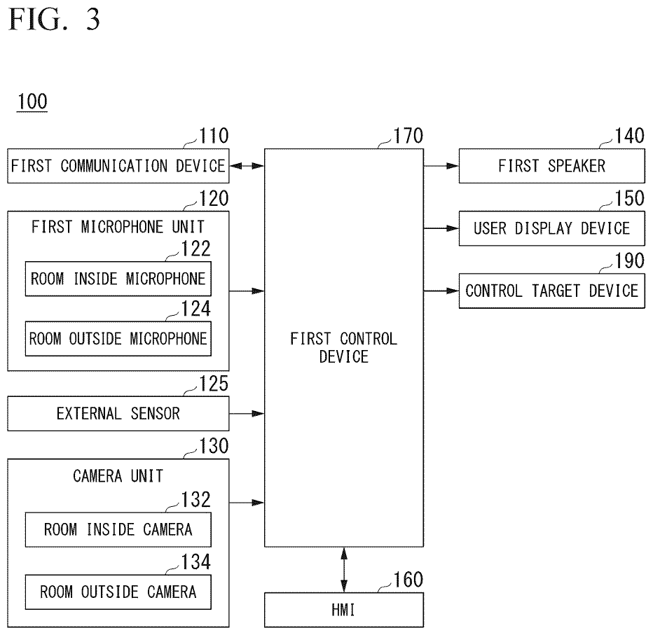

FIG. 3 is a configuration view of the first device 100. The first device 100 includes, for example, a first communication device 110, a first microphone unit 120, an external sensor 125, a camera unit 130, a first speaker 140, a user display device 150, an HMI (Human Machine Interface) 160, and a first control device 170. The first control device 170 is connected to a control target device 190 mounted on the movable body M.

The first communication device 110 is a communication interface for communicating with each of the communication device 310 of the management server 300 and a second communication device 210 of the second device 200 described later via the network NW.

The first microphone unit 120 includes, for example, a room inside microphone 122 and a room outside microphone 124. The room inside microphone 122 is provided at a room inside of the movable body M and collects a vehicle inside sound. Here, the room inside is an example of a “first position”. Further, the vehicle inside sound is an example of a “first sound”. The vehicle inside sound includes a sound generated from the movable body M, that is, for example, a sound of a turn signal, a sound of a wiper, an engine sound, a motor sound, a sound generated from a car audio, a voice emitted by the occupant P, and the like. The room inside microphone 122 may include a non-voice microphone that mainly collects the sound generated from the movable body M and a voice microphone that mainly collects the voice emitted by the occupant P. In this case, a non-voice microphone that mainly collects the sound generated from the movable body M is provided on an instrument panel or the like. The voice microphone that mainly collects the voice emitted by the occupant P is provided in the vicinity of a driver seat S1 or is attached to the occupant P by a pin microphone or the like.

The room outside microphone 124 is provided at a room outside of the movable body M and collects a vehicle outside sound. Here, the room outside is an example of a “second position”. Further, the vehicle outside sound is an example of a “second sound”. The vehicle outside sound may include a wind sound accompanied by the traveling of the movable body M, a travel sound of another vehicle that is different from the movable body M, a sound of a siren, a sound of a horn, a brake sound, a sound generated by an acoustic traffic signal, a chime or a broadcast voice generated from a speaker provided outdoors such as a disaster prevention public administration wireless broadcast, the hustle and bustle including a street speech or conversation between passers, and the like. Further, the vehicle outside sound includes a sound emitted at the vehicle outside in a specific region, that is, for example, a travel sound or a whistle sound of a train, a warning sound of a crossing gate, an announcement of a station, a departure melody, and the like when traveling in the vicinity of a station of a train or a railway track. When traveling in the vicinity of an event facility such as a concert venue, the vehicle outside sound includes cheers, claps, and the like at the venue.

Further, depending on the weather at the time of traveling of the movable body M, the vehicle outside sound may include a rain sound, a wind sound, a sound of a thunder, and the like. Hereinafter, sound information acquired by the room inside microphone 122 may be referred to as “room inside sound information”. Further, sound information acquired by the room outside microphone 124 may be referred to as “room outside sound information”.

The external sensor 125 detects the position of an object in the vicinity of the movable body M. The external sensor 125 is, for example, a radar device, a LIDAR (Light Detection and Ranging) sensor, or other various proximity sensors. The radar device radiates radio waves such as millimeter waves to the vicinity of the movable body M, detects radio waves (reflected waves) reflected by an object, and detects at least the position (a distance and an orientation) of the object. The radar device may detect the position and a speed of the object by a FM-CW (Frequency Modulated Continuous Wave) method. The LIDAR sensor irradiates the vicinity of the movable body M with light (or electromagnetic waves having a wavelength close to that of light), measures the scattered light, and detects the distance to a target based on a time from light emission to light reception. The radiated light is, for example, laser light having a pulse form. The radar device and the LIDAR sensor are attached to an arbitrary position of the movable body M. Further, the external sensor 125 may detect a surrounding object by using a captured image by a room outside camera 134 of the camera unit 130.

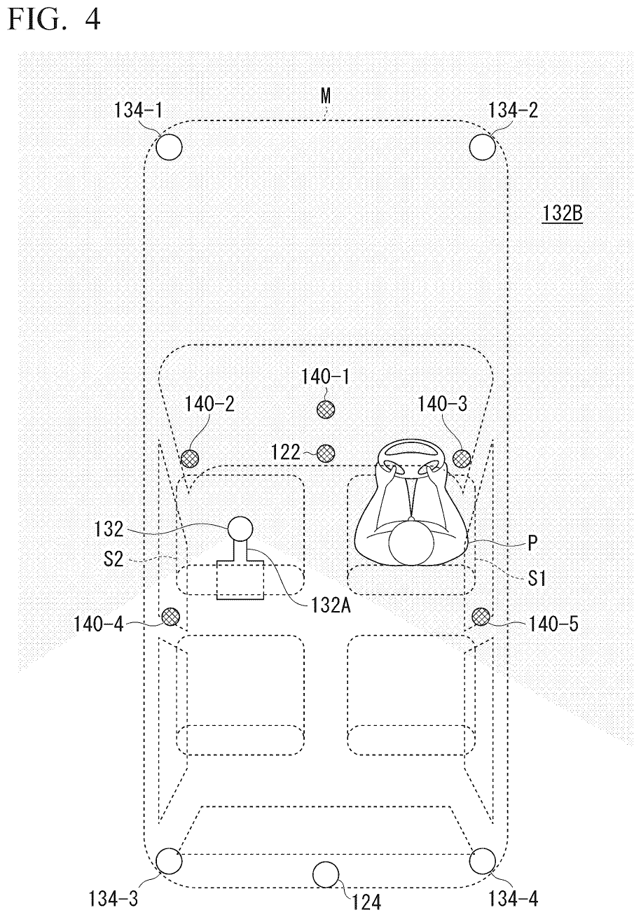

The camera unit 130 includes, for example, a room inside camera 132 and a room outside camera 134. The first speaker 140 outputs a voice that is emitted by the user U and is acquired via the first communication device 110. The details of the arrangement or the like of the camera unit 130 and the first speaker 140 will be described later with reference to FIG. 4.

The user display device 150 virtually displays the user U as if the user U is present at the room inside of the movable body M. For example, the user display device 150 causes a hologram to appear or displays the user U on a portion corresponding to a mirror or a window of the movable body M.

The HMI 160 is a touch panel, a sound response device (agent device), or the like. The HMI 160 receives various commands of the occupant P to the first device 100 and provides various information to the occupant P.

The first control device 170 includes, for example, a processor such as a CPU and a storage medium that is connected to the processor and stores a program (command group) and controls each portion of the first device 100 by the processor executing the command group.

The control target device 190 is, for example, an in-vehicle device such as a navigation device that guides a route to a destination and is mounted on the movable body M or a drive assist device that controls one or both of the steering and the speed of the movable body M and assists driving of the occupant P. The control target device 190 includes, for example, a seat drive device capable of adjusting the position (forward, rearward, leftward, and rightward), the orientation, and the height of a seat. When a video is seen by the second device 200 and when the camera unit 130 of the first device 100 is attached to the seat, the movement of the seat is prohibited, and thereby, it is possible to reduce an influence given to the video. Further, even when the movement of the seat is allowed, a process of a view angle conversion or the like may be performed so as not to affect the video when the seat movement is performed. Further, by a request from the user U, when the user U wants to see a video outside the view angle of the camera unit 130 in the present situation, the seat drive device may be controlled as a request from the second device 200 side.

FIG. 4 is a view showing an example of an arrangement of part of the first device 100 in the movable body M. The room inside microphone 122 is provided, for example, on a middle of a lower portion of the instrument panel. The room outside microphone 124 is provided, for example, on a middle of an upper portion on the outside of a back door. Further, the room outside microphone 124 may be provided on a roof of the movable body M. Here, the case where the room outside microphone 124 is provided on the movable body M is described as an example, but the embodiment is not limited to this. The room outside microphone 124 is not necessarily attached to the movable body M as long as the room outside microphone 124 can collect at least a sound of the vehicle outside.

The room inside camera 132 is attached, for example, to a neck pillow of a passenger seat S2 (an example of a “predetermined seat”) via an attachment 132A and is provided at a position slightly deviated from a backrest of the passenger seat S2 to a travel direction side of the movable body M. The room inside camera 132 has a wide-angle lens and can capture an image in a range represented by a hatched region 132B in FIG. 4. The room inside camera 132 can image not only the room inside of the movable body M but also the room outside of the movable body M through a window. In the following description, the passenger seat S2 is the predetermined seat, but the predetermined seat may be another seat such as a rear seat.

The room outside camera 134 includes, for example, a plurality of child room outside cameras 134-1 to 134-4. By synthesizing images captured by the plurality of child room outside cameras 134-1 to 134-4, an image such as a panoramic image in which an image of the outside of the movable body M is captured is obtained. Alternatively (or additionally), the room outside camera 134 may include a wide-angle camera provided on the roof of the movable body M.

A camera capable of capturing an image in a rear direction of the passenger seat S2 may be added as the room inside camera 132, and a movable body image described later may be generated as a 360-degree panoramic image by combining images captured by one or more room inside cameras 132 by the first control device 170, or may be generated as a 360-degree panoramic image by appropriately combining images captured by the room inside camera 132 and images captured by the room outside camera 134.

The room outside camera 134 may be a 360-degree camera. Further, the room inside camera 132 may be a 360-degree camera.

Further, a plurality of room inside microphones 122 may be provided at the room inside of the movable body M. For example, the room inside microphone 122 may be provided at each position where the room inside camera 132 is provided.

Further, a plurality of room outside microphones 124 may be provided at the room outside of the movable body M. For example, the room outside microphone 124 may be provided at each position where the room outside camera 134 is provided. In this case, for example, a camera with a microphone in which a camera and a microphone are integrated can be used.

The first speaker 140 outputs the voice of the user U acquired via the first communication device 110. The first speaker 140 includes, for example, a plurality of child first speakers 140-1 to 140-5. For example, a child first speaker 140-1 is arranged on an instrument panel middle portion, a child first speaker 140-2 is arranged on an instrument panel left end portion, a child first speaker 140-3 is arranged on an instrument panel right end portion, a child first speaker 140-4 is arranged on a left door lower portion, and a child first speaker 140-5 is arranged on a right door lower portion. When causing the first speaker 140 to output the voice of the user U, for example, by outputting the voice at a volume of the same degree from the child first speaker 140-2 and the child first speaker 140-4 and turning off the other child first speakers, the first control device 170 performs sound image localization so that the occupant P seated in the driver seat S1 hears the voice from the passenger seat S2. Further, the method of the sound image localization is not limited to the adjustment of the volume and may be performed by shifting the phases of the sounds that are output from the child first speakers, respectively. For example, in the case where the sound image localization is performed so that the sound is heard from the left side, the timing of outputting a sound from the left child first speaker may be set to be slightly earlier than the timing of outputting the same sound from the right child first speaker.

Further, when causing the first speaker 140 to output the voice of the user U, the first control device 170 may perform the sound image localization so that the occupant P hears the voice from a position at a height corresponding to a height of a head portion of the user U on the passenger seat S2 and may cause the first speaker 140 to output the voice emitted by the user U. In this case, it is necessary for the first speaker 140 to have a plurality of child first speakers 140-k (k is a plurality of natural numbers) having a different height.

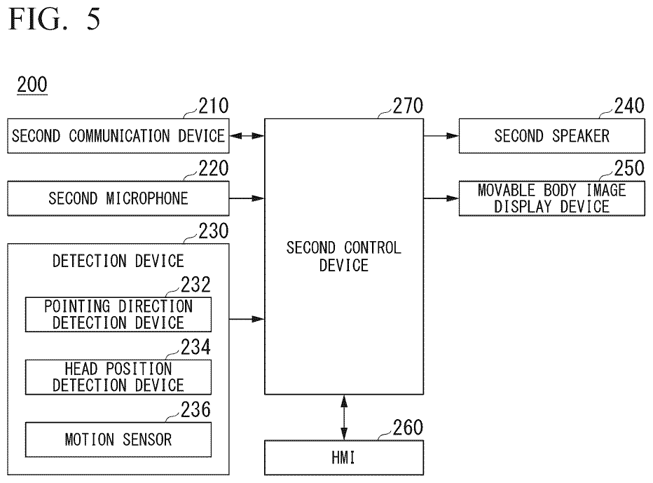

FIG. 5 is a configuration view of the second device 200. The second device 200 includes, for example, the second communication device 210, a second microphone 220, a detection device 230, a second speaker 240, a movable body image display device 250, an HMI 260, and a second control device 270. The detection device 230 includes, for example, a pointing direction detection device 232, a head position detection device 234, and a motion sensor 236.

The second communication device 210 is a communication interface for communicating with each of the communication device 310 of the management server 300 and the first communication device 110 of the first device 100 via the network NW.

The second microphone 220 collects a voice emitted by the user U and a sound (for example, a standing sound generated when the user performs a motion of standing up from a seated posture or the like) generated in a space where the user U is present. The voice collected by the second microphone 220 is transmitted to the first communication device 110 by the second communication device 210, for example, via the second control device 270.

The pointing direction detection device 232 is a device for detecting a pointing direction. The pointing direction is a direction based on a direction of a face or a direction of a sight line of the user U, or both of the directions of the face and the sight line. In the following description, the pointing direction is an angle in a horizontal plane, that is, an angle that does not have a component in an upward-downward direction; however, the pointing direction may be an angle that also includes a component in the upward-downward direction. The pointing direction detection device 232 may include a physical sensor (for example, an acceleration sensor, a gyro sensor, or the like) attached to VR goggles described later, or may be an infrared sensor that detects a plurality of positions of the head portion of the user U or a camera that captures an image of the head portion of the user U. In both cases, the second control device 270 calculates the pointing direction based on the information that is input from the pointing direction detection device 232. Since various techniques about this are known, detailed descriptions thereof are omitted.

The head position detection device 234 is a device for detecting the position (height) of the head portion of the user U. For example, one or more infrared sensors or optical sensors provided around a seat on which the user U is seated are used as the head position detection device 234. In this case, the second control device 270 detects the position of the head portion of the user U based on the presence or absence of a detection signal by the one or more infrared sensors or optical sensors. Further, the head position detection device 234 may be an acceleration sensor attached to the VR goggles. In this case, the second control device 270 detects the position of the head portion of the user U by integrating values obtained by subtracting the gravitational acceleration from an output of the acceleration sensor. The information of the position of the head portion acquired in this way is provided to the second control device 270 as height information.

The position of the head portion of the user may be acquired based on an operation of the user U to the HMI 260. For example, the user U may input the body height by numbers to the HMI 260, or may input the body height by using a dial switch included in the HMI 260. In these cases, the position of the head portion, that is, the height information is calculated from the body height. Further, the user U may input a discrete value such as a body type: large/medium/small instead of a continuous value to the HMI 260. In this case, the height information is acquired based on the information indicating the body type. Further, the height of the head portion of the user U may be simply acquired based on the body type of a general adult (which may be classified into males and females) without acquiring the height of the head portion of the user.

The motion sensor 236 is a device for recognizing the blink and a gesture operation that are performed by the user U. For example, a camera that captures an image of an upper body of the user U is used as the motion sensor 236. In this case, the second control device extracts a feature point (the eye, the nose, or the mouth) of the face of the user U and a feature point (the fingertip, the wrist, the elbow, or the like) of the body of the user U from the image captured by the camera, and recognizes the blink, the movement of the eye, and the gesture operation of the user U based on the movement of the feature points.

The second speaker 240 outputs a sound in which the vehicle outside sound and the vehicle inside sound that are collected by the first microphone unit 120 of the movable body M and are acquired via the second communication device 210 are mixed.

The second speaker 240 may have, for example, a function of changing a direction from which a sound is heard. When mainly outputting a voice emitted by the occupant P to the user U, the second control device 270 may cause the second speaker to output the voice so that the voice is heard from the position of the occupant P when seen from the passenger seat S2. The second speaker 240 includes a plurality of child second speakers 240-n (n is a plurality of natural numbers). The sound image localization may be performed by adjusting the volume of each of the child second speakers 240-n by the second control device 270, or when a headphone is attached to the VR goggles, the sound image localization may be performed by using the function of the headphone.

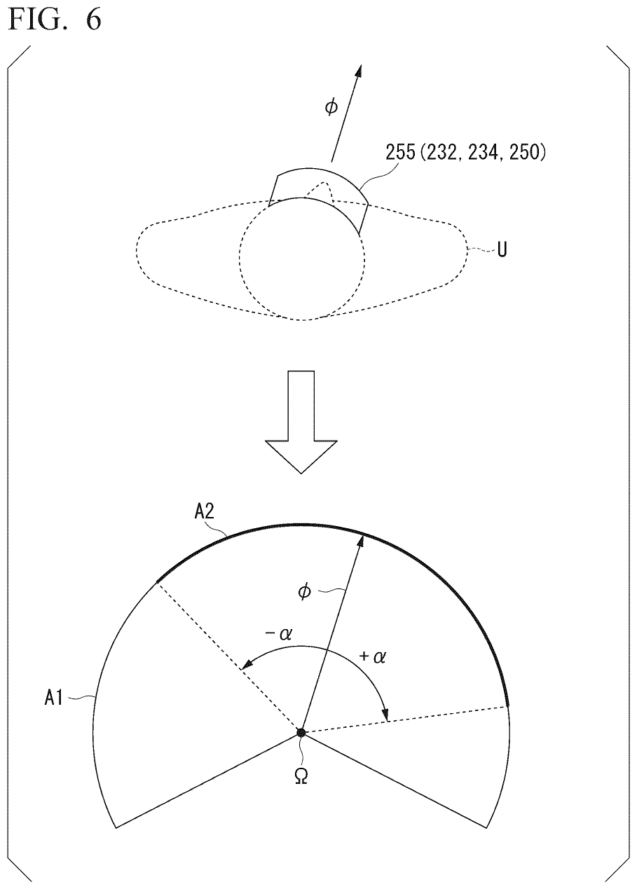

The movable body image display device 250 displays an image corresponding to the pointing direction seen from the passenger seat among images (that may be an image on which a combination process described above is performed and will be referred to as a movable body image) captured by the camera unit 130. FIG. 6 is a view showing an image corresponding to the pointing direction. In the example of FIG. 6, a VR goggles 255 includes a physical sensor as the pointing direction detection device 232 and the head position detection device 234, and the movable body image display device 250. The second control device 270 detects, as a pointing direction φ, a direction which the VR goggles 255 faces, for example, in which a head portion center of the user U or the center of the VR goggles 255 is Ω, and a direction calibrated in advance is a reference direction. Since various methods have been already known with respect to such a function, detailed descriptions thereof are omitted.

The movable body image display device 250 displays, toward the user U, an image A2 of an angle range of ±α in which the pointing direction φ is a center in a movable body image A1 (which has an angle of about 240 degrees in the drawing, but the view angle may be expanded by the combination process as described above).

The HMI 260 is a touch panel, a sound response device (agent device), a switch described above, or the like. The HMI 260 receives various commands of the user U to the second device 200.

The second control device 270 includes, for example, a processor such as a CPU and a storage medium that is connected to the processor and stores a program (command group) and controls each portion of the second device 200 by the processor executing the command group. The second device 200 may have a configuration in which all of the functions shown in FIG. 5 are integrated into the VR goggles.

### Functional Configurations of First Control Device 170 and Second Control Device 270

Hereinafter, functional configurations of the first control device 170 and the second control device 270 are described. In a first example and a second example described below, generation, transmission, and the like of information provided between the first control device 170 and the second control device 270 are mainly performed, and the management server 300 manages the matching of the simulation boarding between the occupant P and the user U.

### First Example

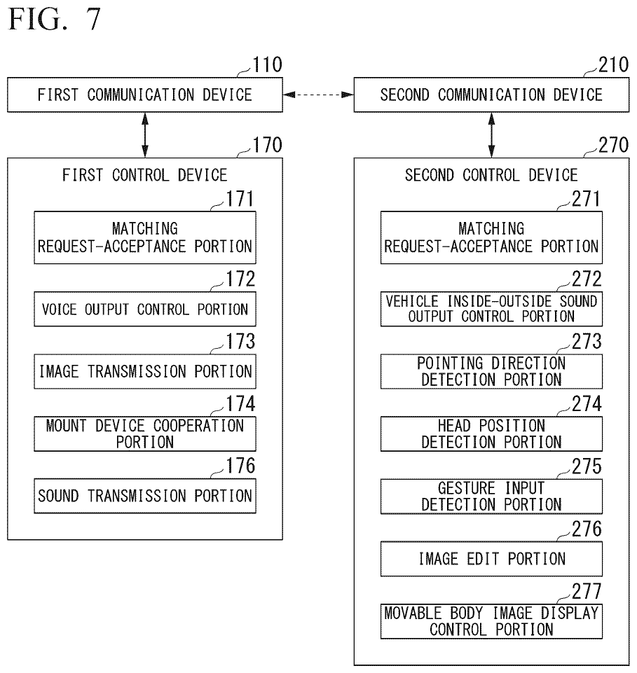

FIG. 7 is a view showing a first example of a functional configuration of the first control device 170 and the second control device 270. In the first example, the first control device 170 includes a matching request-acceptance portion 171, a voice output control portion 172, an image transmission portion 173, and a mount device cooperation portion 174. The second control device 270 includes a matching request-acceptance portion 271, a vehicle inside-outside sound output control portion 272, a pointing direction detection portion 273, a head position detection portion 274, a gesture input detection portion 275, an image edit portion 276, and a movable body image display control portion 277. These functional portions are realized, for example, by a hardware processor such as a CPU executing a program (command group). Part or all of these components may be realized by hardware (a circuit portion; including circuitry) such as an LSI, an ASIC, a FPGA, or a GPU, or may be realized by the cooperation of software and hardware.

The matching request-acceptance portion 171 receives an input of a matching request (simulation boarding request) from the occupant P by using the HMI 160 and transmits the matching request to the management server 300. The matching request-acceptance portion 171 receives an input of acceptance to the matching request received from the management server 300 by using the HMI 160 and transmits the acceptance to the management server 300. The matching request-acceptance portion 171 controls the first communication device 110 so that the second device 200 of the user U with which the matching is established is a communication partner. Further, the matching request-acceptance portion 171 may receive, for example, the setting of provision availability information indicating what kind of information is permitted to be provided from the occupant P when accepting the matching request obtained from the management server 300.

The voice output control portion 172 controls the first speaker 140 as described above.

After the communication with the second device 200 is started, the image transmission portion 173 transmits the movable body image A1 to the second device 200 by using the first communication device 110. The movable body image A1 may include, for example, a room inside image captured by the room inside camera 132 and/or a room outside image captured by the room outside camera 134.

The mount device cooperation portion 174 controls the control target device 190 based on a command signal input from the second device 200. The mount device cooperation portion 174 may perform a control when the control of the control target device 190 by the user U is permitted from the occupant P.

After the communication with the second device 200 is started, a sound transmission portion 176 transmits sound information of a sound collected by the first microphone unit 120, that is, vehicle inside sound information and vehicle outside sound information to the second device 200.

The matching request-acceptance portion 271 receives an input of a matching request (simulation boarding request) from the user U by using the HMI 260 and transmits the matching request to the management server 300. The matching request-acceptance portion 271 receives an input of acceptance to the matching request received from the management server 300 by using the HMI 260 and transmits the acceptance to the management server 300. The matching request-acceptance portion 271 controls the second communication device 210 so that the first device 100 of the occupant P with which the matching is established is a communication partner. Further, the matching request-acceptance portion 271 may receive a command of whether or not the simulation boarding is performed from the user U, for example, after what kind of information is provided to the user U is provided to and confirmed by the user U based on the matching result (request result) obtained from the management server 300.

The pointing direction detection portion 273 detects a pointing direction φ based on an output of the pointing direction detection device 232. The head position detection portion 274 detects the height of the head portion of the user U based on an output of the head position detection device 234. The head position may be represented as a three-dimensional coordinate, or the height of the head portion may be simply detected as the head position. The gesture input detection portion 275 detects the blink, the movement of the eye, the gesture operation, and the like of the user U based on an output of the motion sensor 236.

The vehicle inside-outside sound output control portion 272 controls the second speaker 240 as described above. The vehicle inside-outside sound output control portion 272 causes the second speaker 240 to output a sound based on the sound information transmitted to the second device 200 via the first communication device 110 by the sound transmission portion 176 of the first device 100. The vehicle inside-outside sound output control portion 272 adjusts the sound volume ratio of the vehicle inside sound and the vehicle outside sound in accordance with a motion of the user U and outputs the sound having the adjusted sound volume ratio from the second speaker 240. For example, the vehicle inside-outside sound output control portion 272 outputs a sound in which the sound volume of the vehicle outside sound is smaller than that of the vehicle inside sound from the second speaker 240 in response to the user U being in a first posture corresponding to a posture of being at a room inside of the movable body M.

The first posture is a posture corresponding to a posture of boarding in the passenger seat S2 and is, for example, a seated posture or the like. Further, the vehicle inside-outside sound output control portion 272 outputs a sound in which the sound volume of the vehicle outside sound is larger than that of the vehicle inside sound from the second speaker 240 in response to the user U being in a second posture corresponding to a posture of being at a room outside of the movable body M. The first posture is a posture corresponding to a posture of moving to the vehicle outside of the movable body M or moving a portion of the body to the vehicle outside of the movable body M and is, for example, a posture of standing up, a posture of facing sideways, or the like. Further, the second posture may include a motion corresponding to an operation of opening a front window of the movable body M, a motion of opening a front door, and the like. The motion of the user can be specified by using the detection results of all or part of the pointing direction detection portion 273, the head position detection portion 274, and the gesture input detection portion 275.

Depending on the physical characteristics of the user, all or part of the motions of maintaining the seated posture, standing up, and facing sideways may be difficult. Even in such a case, it is desirable that it is possible to perform a simulation boarding experience having a sense of presence. As a countermeasure against this, a motion corresponding to the first posture and a motion corresponding to the second posture in accordance with the user U may be set in advance. For example, for a user who has difficulty in maintaining a seated posture, a lying posture, that is, for example, a side lying position or a lateral position is set as the first posture. Further, for a user who can sit but has difficulty in standing up, a motion of directing the face upward while sitting is set as the second posture. Further, for a user who has difficulty in turning the face upward or sideways, a motion of directing the eye line in an upward direction or a lateral direction may be set as the second posture. The motion corresponding to the first posture and the motion corresponding to the second posture in accordance with the user U can be stored in advance, for example, in the user list 360B of the user data 360.

Further, it may not be permitted to provide the voice of the occupant P to the user U by a provision availability setting by the occupant P or the like. In such a case, the vehicle inside-outside sound output control portion 272 generates a voiceless vehicle inside sound in which a voice is removed from a vehicle inside sound and outputs the generated voiceless vehicle inside sound from the second speaker 240. For example, the vehicle inside-outside sound output control portion 272 extracts a sound component and a non-sound component (a sound of a turn signal, a sound of a wiper, an engine sound, a motor sound, and the like) based on characteristic information such as a frequency of a sound included in the room inside sound information or the like and adjusts each extracted component. Alternatively, when the room inside microphone 122 is constituted of a non-voice microphone and a voice microphone, the vehicle inside-outside sound output control portion 272 removes a component of a sound (voice) collected by the voice microphone from a sound collected by the non-voice microphone. As a method of removing a component of a sound, existing techniques such as, for example, an effect process or a noise cancellation technique can be used.

The image edit portion 276 performs, for example, a process of cutting out an image A2 corresponding to a pointing direction φ seen from the passenger seat S2 from the movable body image A1 (FIG. 6). The example of FIG. 6 shows a pointing direction φ with respect to the movement in a rightward-leftward direction of the head portion of the user U, but a process of cutting out an image corresponding to a pointing direction with respect to the movement in an upward-downward direction of the head portion may be performed. The movable body image display control portion 277 causes the movable body image display device 250 to display the image A2 that is cut out by the image edit portion 276. At this time, the image edit portion 276 may cause the movable body image display device 250 to display an image corresponding to the pointing direction φ seen from a height indicated by the height information of the head portion of the user U. For example, the image edit portion 276 switches between the room inside image and the room outside image and displays the room inside image or the room outside image in accordance with the distance (for example, a movement amount in an upward direction or a movement amount in a lateral direction) from a reference position of the head portion of the user U.

### Second Example

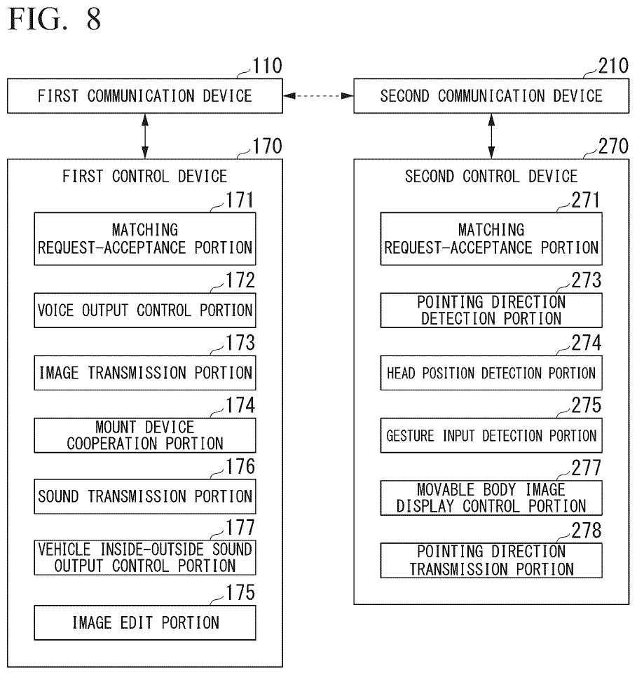

FIG. 8 is a view showing a second example of the functional configuration of the first control device 170 and the second control device 270. When comparing with the first example of FIG. 7, a point that the first control device 170 includes an image edit portion 175 and a vehicle inside-outside sound output control portion 177 is different. Further, a point that the second control device 270 does not include an image edit portion 276 but includes a pointing direction transmission portion 278 is different. Further, a point that the second control device 270 does not include a vehicle inside-outside sound output control portion 272 is different. Other components have basically the same functions as those of the first example, and therefore, repeated descriptions are omitted.

The pointing direction transmission portion 278 transmits the pointing direction φ detected by the pointing direction detection portion 273 to the first device 100 by using the second communication device 210. Further, the pointing direction transmission portion 278 may transmit the motion of the user detected by all or part of the pointing direction detection portion 273, the head position detection portion 274, and the gesture input detection portion 275 to the first device 100 by using the second communication device 210.

The image edit portion 175 performs a process of cutting out the image A2 corresponding to the pointing direction φ (transmitted from the second device 200) seen from the passenger seat from the movable body image A1 (FIG. 6). At this time, the image edit portion 175 may acquire height information of the head portion of the user U from the second device 200 in advance and perform a process of cutting out the image A2 corresponding to the pointing direction φ seen from a height indicated by the height information.

The image transmission portion 173 in the second example transmits the image A2 that is cut out by the image edit portion 175 to the second device 200 by using the first communication device 110. Then, the movable body image display control portion 277 causes the movable body image display device 250 to display the image A2 transmitted from the first device 100.

The vehicle inside-outside sound output control portion 177 adjusts the sound volume ratio of a vehicle inside sound and a vehicle outside sound in accordance with a motion (transmitted from the second device 200) of the user.

Further, when it is not permitted to provide the voice of the occupant P to the user, the vehicle inside-outside sound output control portion 177 generates a voiceless vehicle inside sound in which the voice is removed from the vehicle inside sound. As a method of generating the voiceless vehicle inside sound, a method similar to that of the vehicle inside-outside sound output control portion 272 can be employed. The vehicle inside-outside sound output control portion 177 generates the voiceless vehicle inside sound, and thereby, a control can be performed so that provision information (here, the voice of the occupant P) that is not permitted is not transmitted to the second device 200.

The sound transmission portion 176 in the second example transmits sound information of a sound in which the sound volume ratio of the vehicle inside sound and the vehicle outside sound is adjusted by the vehicle inside-outside sound output control portion 177 to the second device 200 by using the first communication device 110. Then, the second control device 270 outputs, from the second speaker 240, a sound based on the sound information in which the sound volume ratio of the vehicle inside sound and the vehicle outside sound is adjusted and which is transmitted from the first device 100.

Part (for example, a function of generating a voiceless vehicle inside sound) of the functions of the vehicle inside-outside sound output control portion 272 may be provided on the first device 100 as the vehicle inside-outside sound output control portion 177. In this case, the first device 100 generates a voiceless vehicle inside sound from vehicle inside sound information collected by the room inside microphone 122, and transmits the generated voiceless vehicle inside sound and vehicle outside sound information collected by the room outside microphone 124 to the second device 200. The second device 200 mixes the sound information of the voiceless vehicle inside sound and the vehicle outside sound received from the first device 100, and outputs, from the second speaker 240, a sound in which the sound volume ratio of the vehicle inside sound and the vehicle outside sound is changed in accordance with the motion of the user U.

### Process Relating to Simulation Boarding

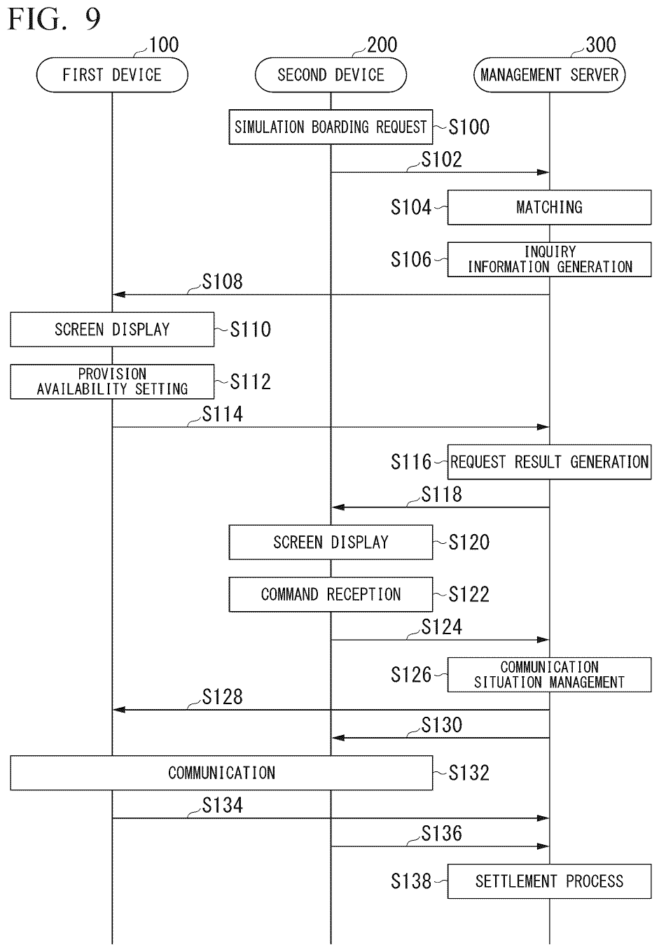

Next, in the embodiment, a series of processes performed by the information processing system 1 when the user U performs the simulation boarding on the movable body M (the occupant P causes the user U to perform the simulation boarding) are specifically described. FIG. 9 is a sequence view showing an example of a process performed by the information processing system 1. In the example of FIG. 9, a process in the first device 100 mounted on the movable body M on which the occupant P is boarding, the second device 200 used by the user U, and the management server 300 is shown. Further, it is assumed that the user U and the occupant P are registered in the management server 300 in advance and are registered in the user data 360 in order to receive the provision of the service in the information processing system 1.

In the example of FIG. 9, the second device 200 generates a request (simulation boarding request) for performing a simulation boarding (Step S100), and transmits the generated simulation boarding request to the management server 300 (Step S102). The simulation boarding request may include, for example, information specifying the occupant P in advance or may include information specifying a current position, a destination, a surrounding situation or the like of the movable body M during traveling. More specific examples of the simulation boarding request include, for example, a request “I want to perform a simulation boarding on a movable body which Mr. A is driving” or a request “I want to perform a simulation boarding on a movable body which is traveling on a road along the sea”. These are examples of the matching requests described above.

The matching process portion 320 of the management server 300 receives the simulation experience request from the second device 200 and performs a matching process based on the user data 360 (Step S104). Then, when one or more matched movable bodies M are present, the provision portion 330 generates inquiry information that inquires whether or not the simulation boarding is performed to all of the movable bodies M (Step S106), and transmits the generated information to the first device 100 of the matched movable body M (Step S108).

The first device 100 displays the inquiry information transmitted from the management server 300 on a screen (Step S110). On the screen, together with a guide sentence “There is a simulation boarding request. Do you permit the request?” or the like, user information relating to the user U who provides the simulation boarding request, a selection image for selecting the contents of information to be provided to the user U by the occupant P, a reception button that receives whether or not to permit the simulation boarding of the user U by the occupant P, and the like are displayed. In the selection image, for example, a conversation (voice), a vehicle inside sound, a vehicle outside sound, a room inside image, a room outside image, and navigation information (information provided from the navigation device) are displayed as information which the occupant P can select whether or not the information is provided to the user U. For example, the occupant P rejects the provision of the conversation (voice) and permits the provision of the vehicle inside sound and the vehicle outside sound with respect to the user U who is not very familiar with the occupant P. Thereby, it is possible to perform driving without talking.

The first device 100 receives provision availability setting to the user U by displaying an image of the inquiry information described above (Step S112), and transmits received provision availability setting information to the management server 300 (Step S114). The processes of Step S110 to S112 may be displayed on the screen when the movable body M stops in order to ensure safety during driving, and it may be notified that there is the simulation boarding request, or the provision availability setting may be received by using voice instead of (or in addition to) the screen display. The provision portion 330 of the management server 300 generates a request result (answer result) based on the provision availability setting information obtained from the first device 100 (Step S116), and transmits information indicating the generated request result to the second device 200 (Step S118).

The second device 200 receives the request result from the management server 300 and displays information indicating the received request result on the screen (Step S120). On the screen, together with a guide sentence “The simulation boarding is permitted. Do you board?” or the like, a list image indicating a list of provision information, a reception button that receives whether or not to the simulation boarding is performed or whether another vehicle is searched, and the like are displayed. The image may be generated for each occupant P (movable body M) who permits the simulation boarding, and an image indicating a list of the request result may be further displayed.

The second device 200 receives a selection command from the user U described above (Step S122), and transmits received command information to the management server 300 (Step S124). In the following description, it is assumed that a command in which the user U performs the simulation boarding on the movable body M of the occupant P is issued. The management server 300 manages a communication situation of the first device 100 and the second device 200 based on the command from the second device 200 (Step S126), and transmits information indicating that the simulation boarding is performed to the first device 100 and the second device 200 (Step S128 and S130). When it is selected in the processes of Step S126 to S130 that the user U does not perform the simulation boarding, the provision portion 330 of the management server 300 transmits information indicating the selection to the first device 100 and notifies the user U.

Next, the first device 100 and the second device 200 communicate with each other and perform the simulation boarding (Step S132), and when the simulation boarding is completed, the first device 100 and the second device 200 transmit information indicating that the communication is completed to the management server 300 (Step S134 and S136). The fee management portion 340 of the management server 300 performs a settlement process of the fee relating to the service use of each of the first device 100 and the second device 200 (Step S138). Thereby, the process of the present sequence is ended. The process (provision availability setting process) of Step S112 shown in FIG. 9 may be set for each registered user U by the occupant P in advance.

### Information Provided at Simulation Boarding

Next, the information provided to the user U at the time of the simulation boarding is described by using several examples. The following examples are information provided in the process of Step S132 shown in FIG. 9, and an output mode of the information provided to the second device 200 differs depending on, for example, a motion by the user U and the type or the information amount of the information that can be provided to the user U. In the following examples, it is assumed that the provision of the room inside image, the room outside image, the vehicle inside sound, the vehicle outside sound, and the conversation (voice) is permitted by the occupant P.

### Example of First Provision Information: Information Provided in Seated Posture

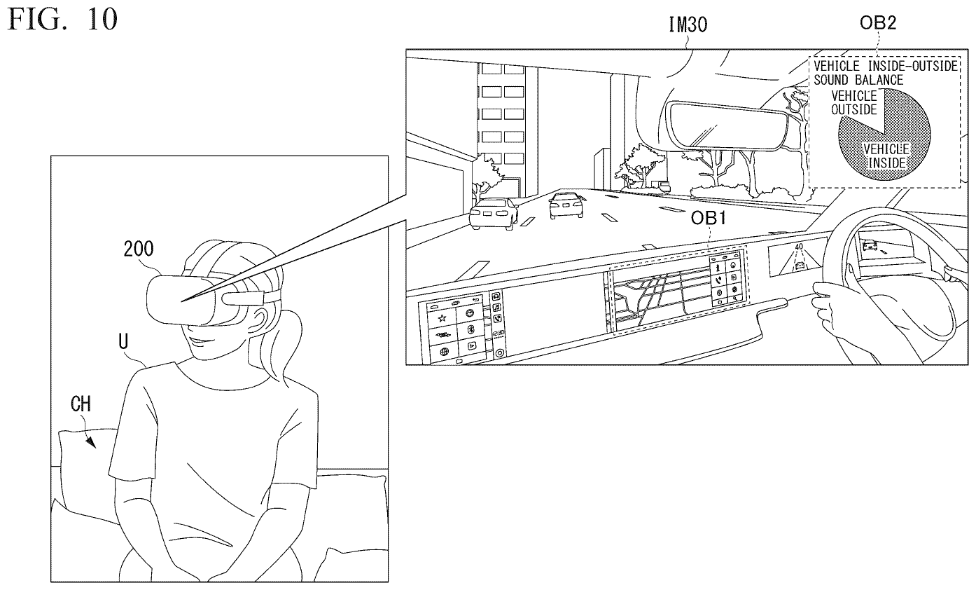

FIG. 10 is a view showing an example of first provision information. In the example of FIG. 10, an example of the user U seated on a chair CH in a place (for example, a room of a home) or the like other than the movable body M and an image IM30 provided from the second device 200 (VR goggles integration type in the example of FIG. 10) used by the user U is shown. The state (a state seated on the chair CH) of the user U shown in the example of FIG. 10 shows an initial state immediately after the simulation boarding is performed, and the first device 100 and the second device 200 recognize the position (reference posture) of the user U at this time as a reference position. The reference position is a position where it is assumed that the user U is seated in the passenger seat S2. The first control device 170 drives the seat drive device based on body type information such as body height or seating height information of the user U registered in the user information of the user data 360, and thereby, the reference position may be corrected so that the height of the room inside camera 132 matches the seating height of the user U (so-called zero point correction). Further, the reference position may be corrected by a correction command from the user U who sees the image IM30. Further, the reference position may include orientation information when the user U is seated on the chair CH and faces the front side.

For example, in a state where the user U is seated on the chair CH, when the user U (second device 200) faces an arbitrary direction from the reference position, in accordance with the direction, an image captured by the room inside camera 132 of the first device 100 is provided as a room inside image IM30. Thereby, the user U can acquire a room inside image in an arbitrary direction seen from the passenger seat S2.

Further, sound information of the vehicle inside sound including the voice of the occupant P and the vehicle outside sound acquired by the first microphone unit 120 is provided to the user U. When the user U is at the reference position, that is, when the user U is in a seated posture on the chair CH as shown in FIG. 10, the vehicle inside-outside sound output control portion 272 mixes the vehicle inside sound information and the vehicle outside sound information so that the sound volume of the vehicle inside sound becomes larger than the sound volume of the vehicle outside sound. For example, the vehicle inside-outside sound output control portion 272 mixes the vehicle inside sound information and the vehicle outside sound information at the sound volume ratio of a degree in which the vehicle inside sound is heard loudly and the vehicle outside sound is heard faintly. The vehicle inside-outside sound output control portion 272 outputs the sound information of the mixed sound from the second speaker 240. The user U can hear the voice of the occupant P, the sound of the turn signal, and the like as the vehicle inside sound by being seated on the chair CH, and can also hear a slightly mixed sound of the vehicle outside by listening carefully. Thereby, the user can perform an experience as if the user actually boards on the movable body M and has a conversation with the occupant P.

Further, the information processing system 1 is described using an example in which the user U can visually recognize an arbitrary direction seen from the passenger seat S2, but the direction in which the user U can visually recognize may be limited by, for example, an agreement at the time of matching, a provision availability setting of the occupant P, or the like. For example, at the side of the occupant P, a request may occur in which, although the landscape in the travel direction of the movable body M or the landscape on the opposite side of the driver seat S1 may be provided, the occupant P does not want to display the figure of the occupant P. This is assumed to meet the needs that the occupant P and the user U are not in a relationship such as a family or a friend but want to confirm the drive feeling of the movable body M or want to visually recognize the landscape of a desired town. In this case, the matching process portion 320 or the provision portion 330 of the management server 300 sets such a limitation based on the matching result, and the first control device 170 or the second control device 270 masks an angle range that is not to be visually recognized or performs correction so that the pointing direction φ is not directed in a limited direction in accordance with the setting. Further, since the information relating to such a limitation relates to the privacy of the occupant P, the information may be set on the side of the first device 100. Further, the information that is refused to be provided may be provided after the acceptance of the occupant P by the user U paying an additional fee.

Further, the movable body image display device 250 may replace a portion, in which a predetermined article at the room inside of the movable body M is imaged, in an image captured by the camera unit 130 by an image (CG image) drawn by a computer process and may display the image. A region OB1 shown in FIG. 10 is a display device that performs navigation display or the like and is an example of a “predetermined article”. When a captured image of a display screen of the display device is displayed as it is, the image may be blurred, or the visibility may be lowered due to the reflection of light. Therefore, the movable body image display device 250 may acquire data for constituting the display screen of such a display device or image data drawn by a computer process in the movable body M from the first device 100, and may embed an image redrawn by the computer process from the data or the acquired image data in the (edited) image captured by the camera unit 130 and display the image. In this case, the position of the article, which becomes the predetermined article, at the room inside of the movable body M is shared in advance between the first device 100 and the second device 200, and the movable body image display control portion 277 determines whether the predetermined article is included in the image to be displayed on the movable body image display device 250, for example, based on the pointing direction φ, and performs the replacement of the image as described above when it is determined that the predetermined article is included. Further, the “predetermined article” may be the head portion or the face of the occupant P. In that case, a CG image of an avatar or the like may be changed in accordance with the display of the occupant P. At least part of the image data (CG image) described above or the like may be provided from the provision information DB of the management server 300.

Further, the vehicle inside-outside sound output control portion 272 may cause the movable body image display device 250 to display the sound volume ratio of the vehicle inside sound and the vehicle outside sound output from the second speaker 240. In a region OB2 shown in FIG. 10, an image (CG image) in which the sound volume ratio of the vehicle inside sound and the vehicle outside sound is displayed in a circle graph is shown below a title displayed as “vehicle inside-outside sound balance” or the like. By displaying this image, the user can know that the sound volume ratio of the vehicle inside sound and the vehicle outside sound is adjusted, and the sound volume ratio. Further, depending on the user, the travel situation of the movable body M, or the like, there may be cases in which the user wants to adjust the sound volume ratio of the vehicle inside sound and the vehicle outside sound. In order to meet such needs, a configuration may be employed in which the user can finely adjust the sound volume ratio. In this case, for example, an adjustment button for adjusting the sound volume ratio is provided in the region OB2. For example, two operation buttons indicating that “increase the ratio of the vehicle inside sound” and “decrease the ratio of the vehicle inside sound” or the like are displayed. The user U performs an operation of pressing any of the two operation buttons, for example, via the HMI 260. The vehicle inside-outside sound output control portion 272 outputs, from the second speaker 240, a sound in which the sound volume ratio of the vehicle inside sound and the vehicle outside sound is adjusted in accordance with the operation input to the HMI 260.

The vehicle inside-outside sound output control portion 272 may switch the image displayed in the region OB2 to be in either a non-display state or a display state in accordance with the operation of the user or the like.

### Example of Second Provision Information: Information Provided in Standing Posture

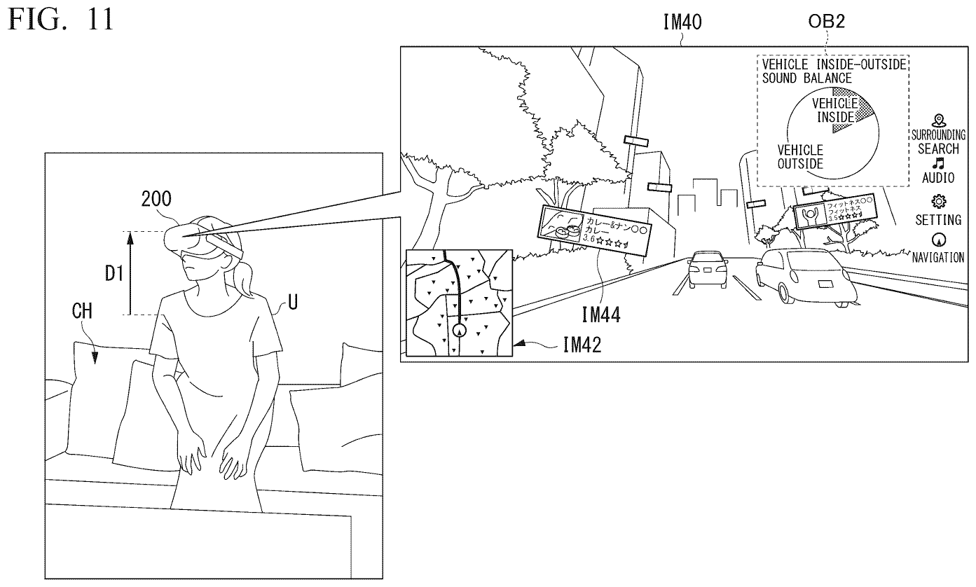

FIG. 11 is a view showing an example of second provision information. In the example of FIG. 11, an image IM40 provided when the height of the head portion (second device 200) of the user U becomes high by a distance D1 from the reference position is shown. In this case, the first device 100 determines whether or not the moved distance D1 is equal to or more than a threshold value, and when the distance D1 is equal to or more than the threshold value, the first device 100 switches the image from the room inside image by the room inside camera 132 to the room outside image by the room outside camera 134 and displays the room outside image. In the example of FIG. 11, since the distance D1 is equal to or more than the threshold value, a room outside image captured from an upper portion of the movable body M is displayed.

Thereby, the user U can obtain an experience specific to the simulation boarding, which is impossible in the actual boarding, such as seeing the surrounding landscape while the user's head is at the outside above the movable body M.

Further, when the height of the head portion (second device 200) of the user U becomes high by the distance D1 from the reference position, the sound volume ratio of the vehicle inside sound and the vehicle outside sound provided to the second device 200 is changed. When the height of the head portion of the user U becomes high by the distance D1 from the reference position and the user U becomes a standing posture from the chair CH, the vehicle inside-outside sound output control portion 272 mixes the vehicle inside sound information and the vehicle outside sound information so that the sound volume of the vehicle inside sound becomes smaller than the sound volume of the vehicle outside sound. For example, the vehicle inside-outside sound output control portion 272 mixes the vehicle inside sound information and the vehicle outside sound information at the sound volume ratio at which the vehicle inside sound is heard faintly and the vehicle outside sound is heard loudly. The vehicle inside-outside sound output control portion 272 outputs sound information of the mixed sound from the second speaker 240. By standing up from the chair CH, the user U can loudly and clearly hear a wind sound, a travel sound of another vehicle, a sound of a siren, and the like as the vehicle outside sound. Further, by listening carefully, it is also possible to faintly hear a sound of the vehicle inside. Thereby, the user can obtain an experience specific to the simulation boarding, which is impossible in the actual boarding, such as hearing the outside sound while the user's head is at the outside above the movable body M.

The threshold value described above may be a fixed value or may be variably set in accordance with the vehicle type of the movable body M. For example, the first device 100 switches the image to the room outside image when the distance D1 from the reference position is equal to or more than the vehicle type (an outer shape of the vehicle) based on the distance D1 and the vehicle type information included in the movable body information stored in the user data 360. Thereby, for example, when performing a simulation boarding on a large-sized vehicle such as a bus, since the room inside image is maintained even when the user U stands up in the same manner (when moving by the distance D1 shown in FIG. 11), information closer to reality is provided, and therefore, it is possible to prevent the user U from having a feeling of strangeness. Further, the threshold value described above may be set in consideration of the body type of the user U.

In a motion of standing up from the chair CH of the user U, the position of the head portion is moved further forward than a seated state due to the human body structure. However, since the user U thinks that the user U is standing just directly upward, if the room outside image is moved forward in accordance with the forward movement of the head at the time of standing up, a feeling of strangeness may be given to the user U. Accordingly, the first device 100 may perform a correction process so as not to move the room outside image forward when the position of the head of the user U is moved forward by a predetermined distance by the standing up.

Further, in the example of the second provision information, the image IM40 may be displayed so that an image IM42 indicating navigation information and an image IM44 indicating POI information (for example, information of a store) corresponding to the surrounding building or the like are superimposed on the image IM40. Thereby, it is possible to provide more detailed information.

Further, in the region OB2 shown in FIG. 11, an image (CG image) in which the sound volume ratio of the vehicle inside sound and the vehicle outside sound is displayed in a circle graph is shown similarly to FIG. 10. This figure shows that the sound volume ratio is adjusted so that the sound volume of the vehicle outside sound is larger than the sound volume of the vehicle inside sound. Similarly to FIG. 10, the vehicle inside-outside sound output control portion 272 may switch the image displayed in the region OB2 to be in either a non-display state or a display state in accordance with the operation of the user or the like.

### Example of Third Provision Information: Information Provided in Laterally Facing Posture

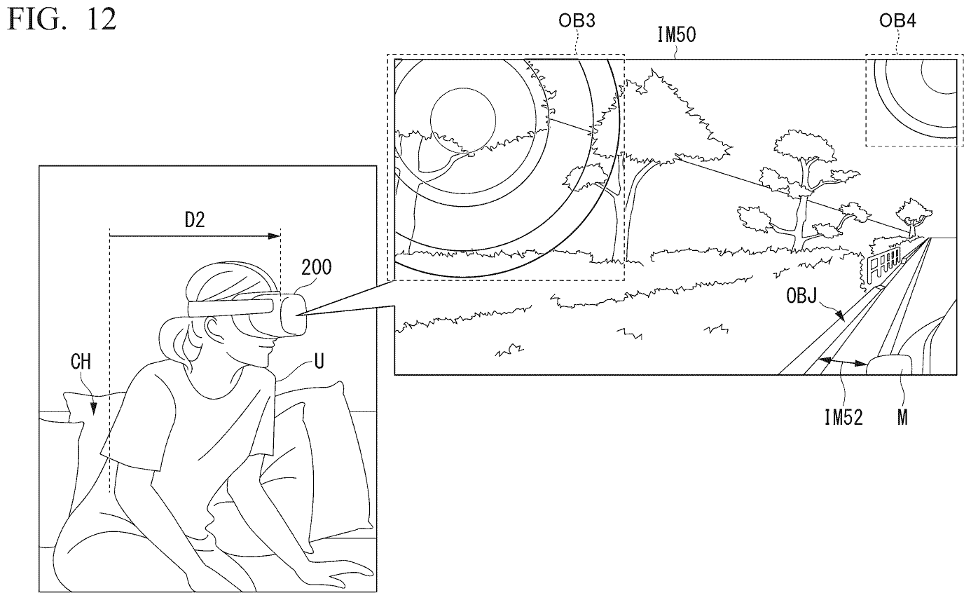

FIG. 12 is a view showing an example of third provision information. FIG. 12 shows an example in which a room outside image on a side of the movable body M is provided instead of an overhead room outside image as compared with the example of FIG. 11. Accordingly, in FIG. 12, the difference from FIG. 11 is mainly described.

In the example of FIG. 12, an image IM50 provided when the position of the head portion (second device 200) of the user U is moved by a distance D2 in a lateral direction from the reference position is shown. In this case, the first device 100 determines whether or not the moved distance D2 is equal to or more than a threshold value, and when the distance D2 is equal to or more than the threshold value, the first device 100 switches the image from the room inside image by the room inside camera 132 to the room outside image by the room outside camera 134 and displays the room outside image. In the example of FIG. 12, since the distance D2 is equal to or more than the threshold value, a room outside image (more specifically, a front image since the user faces slightly forward) captured from a side portion of the movable body M in the moved direction is displayed. Thereby, the user U can obtain an experience specific to the simulation boarding such as seeing the surrounding landscape while the user's head is at the outside to the side (for example, from a side window) of the movable body M. The threshold value described above may be a fixed value or may be variably set in accordance with the vehicle type information of the movable body M.

Further, when the position of the head portion (second device 200) of the user U is moved by the distance D2 in the lateral direction from the reference position, the sound volume ratio of the vehicle inside sound and the vehicle outside sound provided to the second device 200 is changed. When the position of the head portion of the user U is moved by the distance D2 in a left direction from the reference position and the user U becomes a posture facing the left side and performs a motion as if the user U sees the outside from the passenger seat S2, the vehicle inside-outside sound output control portion 272 mixes the vehicle inside sound information and the vehicle outside sound information so that the sound volume of the vehicle inside sound becomes smaller than the sound volume of the vehicle outside sound. On the other hand, when the position of the head portion of the user U is moved by the distance D2 in a right direction from the reference position and the user U becomes a posture facing the right side and performs a motion as if the user U sees the occupant P who is present in the driver seat S1 from the passenger seat S2, the vehicle inside sound information and the vehicle outside sound information are mixed so that the sound volume of the vehicle inside sound (in particular, the voice of the occupant P) becomes larger than the sound volume of the vehicle outside sound. For example, when the room inside microphone 122 is constituted of a non-voice microphone and a voice microphone, the vehicle inside-outside sound output control portion 272 mixes the vehicle inside sound information and the vehicle outside sound information so that the sound volume of a sound collected by the room outside microphone 124 and the non-voice microphone is decreased, and the sound volume of a sound collected by the voice microphone is increased. The vehicle inside-outside sound output control portion 272 outputs the mixed sound from the second speaker 240.

The arrangement of the driver seat S1 and the passenger seat S2 may differ depending on the movable body M. The vehicle inside-outside sound output control portion 272 determines whether the motion in which the position of the head portion of the user moves in the lateral direction from the reference position corresponds to a motion of seeing the outside or corresponds to a motion of seeing the occupant P who is present in the driver seat S1 in accordance with the arrangement of the driver seat S1 and the passenger seat S2 in the movable body M. The arrangement of the driver seat S1 and the passenger seat S2 in the movable body M is stored, for example, in the occupant list 360A in advance. The second device 200 refers to the storage portion 350 of the management server 300 and acquires the arrangement of the driver seat S1 and the passenger seat S2 in the movable body M of the occupant P matched with the user U, which is stored in the occupant list 360A. Thereby, the vehicle inside-outside sound output control portion 272 can acquire the arrangement of the driver seat S1 and the passenger seat S2. The vehicle inside-outside sound output control portion 272 can change the sound volume ratio of the vehicle inside sound and the vehicle outside sound in accordance with the motion of the user based on the acquired arrangement of the driver seat S1 and the passenger seat S2.

Further, when performing the simulation boarding on a large-sized vehicle such as a bus, the motion in which the user U faces the lateral direction may not correspond to the motion of seeing the vehicle outside or the motion of seeing the occupant P but may correspond to a motion of seeing the vehicle inside. In such a case, the vehicle inside-outside sound output control portion 272 changes the sound volume ratio of each component of the vehicle inside sound from the current ratio. For example, the vehicle inside-outside sound output control portion 272 causes the ratio of the sound volume of a non-voice component to be larger (or smaller) than the sound volume of a voice component of the vehicle inside sound. Alternatively, when a plurality of room inside microphones 122 are arranged in the lateral direction, the vehicle inside-outside sound output control portion 272 may change the sound volume ratio so that the sound volume of a sound collected by a room inside microphone 122 arranged in an opposite direction of a direction in which the user U faces becomes smaller than a sound collected by a room inside microphone 122 arranged in the direction in which the user U faces. By changing the sound volume ratio, the user can feel the change of a surrounding sound in accordance with the motion of the user and can experience a simulation boarding having a more sense of presence.

Further, when the plurality of room inside microphones 122 are provided on the movable body M, the vehicle inside-outside sound output control portion 272 may adjust the sound volume ratio of a sound collected from each of the plurality of room inside microphones 122 in accordance with the pointing direction φ of the user. For example, the vehicle inside-outside sound output control portion 272 calculates a linear distance between a straight line corresponding to the pointing direction φ of the user and each of the plurality of room inside microphones 122 and adjusts the sound volume ratio of the sound collected from each of the plurality of room inside microphones 122 in accordance with the calculated distance. The vehicle inside-outside sound output control portion 272 adjusts the sound volume ratio so that the sound volume ratio is larger as the distance to the straight line corresponding to the pointing direction φ is smaller.

Similarly, when a plurality of room outside microphones 124 are provided on the movable body M, the sound volume ratio of a sound collected from each of the plurality of room outside microphones 124 can be adjusted in accordance with the pointing direction φ of the user. The vehicle inside-outside sound output control portion 272 adjusts the sound volume ratio so that the sound volume ratio of a sound collected by a room outside microphone 124 arranged at a position where a linear distance to a straight line corresponding to the pointing direction φ is small becomes larger than a sound collected by a room outside microphone 124 arranged at a position where the linear distance is large.

Since the position of the head may be displaced even in the lateral movement of the user U similarly to the motion of standing up, the first device 100 may perform correction so that there is not any displacement in the image when the displacement amount is a predetermined displacement amount.

Further, the vehicle inside-outside sound output control portion 272 may cause the movable body image display device 250 to display an image (CG image) in accordance with the sound volume ratio of the vehicle inside sound and the vehicle outside sound that are output from the second speaker 240. In the regions OB3 and OB4 shown in FIG. 12, an image of “ripple” that schematically represents a state in which sound waves propagate is shown as an image indicating the magnitude of the vehicle outside sound. In this figure, the radius of the ripple displayed in the region OB3 is displayed to be larger than the radius of the ripple displayed in the region OB4, and thereby, the figure shows that the sound volume of the vehicle outside sound is adjusted to be larger than that of the vehicle inside sound. The vehicle inside-outside sound output control portion 272 may switch the images displayed in the regions OB3 and OB4 to be in either a non-display state or a display state in accordance with the operation of the user or the like.

Further, in the example of the third provision information, in the image IM50, information (for example, an image IM52 or a numerical value indicating the distance) indicating a distance to an obstacle OBJ such as a curb detected by the external sensor 125 may be displayed. In this case, the first device 100 acquires information from the external sensor 125 that recognizes an object in the vicinity of the movable body M and provides the image IM52 indicating a distance between the movable body M and the object (obstacle OBJ) detected by the external sensor 125 when providing a room outside image to the second device 200. Thereby, for example, the user U sees the room outside image IM50 near a road shoulder which becomes a blind area that the occupant P cannot see directly from the driver seat and notifies the occupant P of the content of the room outside image IM50 by conversation, and thereby, it is possible to prevent the contact with the obstacle OBJ and perform further appropriate driving.

Further, when the distance between the movable body M and the object (obstacle OBJ) is within a predetermined distance, the first device 100 may provide the second device 200 with information (for example, alert information) indicating that the movable body M and the object are approaching to each other instead of (or in addition to) the information indicating the distance. Thereby, it is possible to prompt the user U to confirm the vicinity by the vehicle outside image, and the vicinity of the blind area of the occupant P can be further accurately known.

Further, a configuration may be employed in which a sound (motion sound) generated in accordance with the motion of the user U or the occupant P is output in an emphasized manner.

For example, the second microphone 220 amplifies a standing sound (an example of a motion sound) collected at a timing when the height of the head portion (second device 200) of the user U becomes higher by the distance D1 from the reference position, and transmits a sound (amplification sound) after the amplification to the first communication device 110. Thereby, the occupant P easily knows that the user U stands up.

Alternatively, the second microphone 220 amplifies a laterally facing sound (an example of the motion sound) collected at a timing when the position of the head portion (second device 200) of the user U moves by the distance D2 in the lateral direction from the reference position, and transmits a sound (amplification sound) after the amplification to the first device 100. Thereby, the occupant P easily knows that the user U faces in the lateral direction.

Further, the room inside microphone 122 amplifies a motion sound collected at a timing when the motion of the occupant P is detected, and transmits a sound (amplification sound) after the amplification to the second device 200. Thereby, the occupant P easily knows that the user U performs a motion. Here, examples of the motion of the occupant P include reseating by the occupant P in the driver seat, a motion of standing up while lifting the waist, a motion of turning around, a motion of stopping the movable body M and getting out of the movable body M, and the like. These motions of the occupant P can be detected by performing image processing (for example, object recognition) on the image captured by the room inside camera 132.

By the provision information described above, it is possible to provide an image or a voice of a simulation boarding in accordance with a predetermined motion of the user U. In the example described above, the image (the room inside image and the room outside image) is switched in accordance with the movement of the user, and the sound volume ratio of the sound (the vehicle inside sound, the vehicle outside sound, and the voice) is changed; however, the embodiment is not limited thereto. The image may be switched, or the sound volume ratio of the sound may be changed in accordance with a mechanical switch (operation portion) such as a switching button provided on the second device 200, a gesture motion of the user U, an operation portion provided on the first device 100, a gesture motion, or the like regardless of the motion of the user U.

The first to third provision images described above may be provided to the first device 100. Thereby, the occupant P can further accurately know what kind of image the user U is currently seeing, and it is possible to perform further appropriate conversation.

Further, in the embodiment, the first device 100 may generate an image as if the user U is seated in the passenger seat S2 (or the rear seat) and may display the generated image on a rearview mirror display device or a window. In this case, the first control device 170 generates a person image in which the user U or a character corresponding to the user U is seated in the passenger seat S2, and displays the generated image on the rearview mirror display device. In this case, the posture of the person image may be changed in accordance with the motion of the user U obtained from the second device 200. Further, the first control device 170 may control the first speaker 140 so as to output a voice from the vicinity of the passenger seat S2 when the person image is displayed on a rearview mirror display device 152. This voice is, for example, a voice emitted by the user U to the second microphone 220 and is a voice transmitted by the second communication device 210 and acquired via the first communication device 110. The first control device 170 causes the first speaker 140 to output, for example, a voice on which the sound image localization is performed so that the occupant P in the driver seat can hear the voice from the passenger seat S2.

### First Modification Example

In the information processing system 1 described above, at least part of the functions of the first device 100 and the second device 200 may be provided on the management server 300, and at least part of the functions of the management server 300 may be provided on the first device 100 or the second device 200.

For example, the function of the image edit portion 276 (or the image edit portion 175) and the function of the movable body image display control portion 277 described above may be provided on the management server 300. Further, the function of the vehicle inside-outside sound output control portion 272 (or the vehicle inside-outside sound output control portion 177) may be provided on the management server 300.

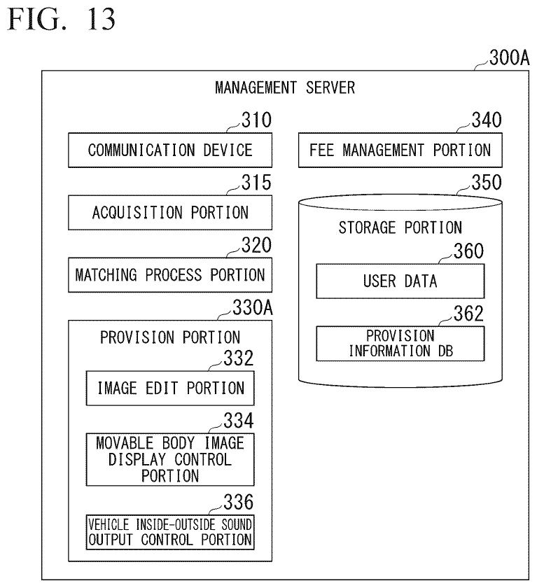

FIG. 13 is a view showing an example of a functional configuration of a management server 300A in a modification example. In the example of FIG. 13, the management server 300A includes, for example, a communication device 310, an acquisition portion 315, a matching process portion 320, a provision portion 330A, a fee management portion 340, and a storage portion 350. In the management server 300A, as compared with the management server 300 shown in FIG. 1, the provision portion 330A is provided instead of the provision portion 330. Accordingly, in the following description, the function of the provision portion 330A is mainly described, and descriptions of other configuration portions are omitted. Further, in the case of the modification example shown in FIG. 13, for example, information acquired by the first device 100 and the second device 200 is acquired by the acquisition portion 315 of the management server 300A, and various information corresponding to each device is provided by the provision portion 330.

For example, the provision portion 330A provides the second device 200 with information set to be capable of being provided among the room inside image, the room outside image, the vehicle inside sound, and the vehicle outside sound based on provision availability information set by the occupant P. For example, the provision portion 330A has a function similar to that of the provision portion 330, and further includes an image edit portion 332, a movable body image display control portion 334, and a vehicle inside-outside sound output control portion 336.

The image edit portion 332 performs a process similar to that of the image edit portion 276 (or the image edit portion 175) described above. For example, the image edit portion 332 acquires an image captured by the first device 100, switches between a room inside image and a room outside image depending on the presence or absence of a predetermined motion based on motion information (position information of the head portion) of the user U detected by the detection device 230 of the second device 200 or the like, and provides the image to the second device 200. In this case, the image edit portion 332 may generate an image in which other information (for example, navigation information or POI information) is superimposed on the room inside image or the room outside image.

The vehicle inside-outside sound output control portion 336 performs a process similar to that of the vehicle inside-outside sound output control portion 272 (or the vehicle inside-outside sound output control portion 177) described above. For example, the vehicle inside-outside sound output control portion 336 acquires the vehicle inside sound and the vehicle outside sound collected by the first device 100, changes the sound volume ratio of the vehicle inside sound and the vehicle outside sound in accordance with a predetermined motion based on motion information (position information of the head portion) of the user U detected by the detection device 230 of the second device 200 or the like, and provides the sound to the second device 200.

The movable body image display control portion 334 provides the image generated by the image edit portion 332 to the second device 200, switches the image based on the motion of the user U, and controls the sound volume ratio of the vehicle inside sound and the vehicle outside sound. For example, the movable body image display control portion 334 outputs, from the second speaker 240, a sound in which the sound volume ratio of the vehicle inside sound and the vehicle outside sound is changed in accordance with the switching of the image.

Further, the provision portion 330A may provide the second device 200 with information relating to a distance between the movable body M and an object (for example, an obstacle) detected by the external sensor 125 when providing the room outside image. Further, when the distance between the movable body M and the object is within a predetermined distance, the provision portion 330A may provide the second device 200 with information indicating that the movable body M and the object are approaching to each other. Further, when there is a request of acquiring information from the first device 100 by the user U, the provision portion 330A may provide the occupant with information indicating that there is the request and may acquire provision availability information set by the occupant P. Further, the provision portion 330A may provide the second device 200 with information for the user U to confirm information relating to the information provided by the first device 100. Further, the provision portion 330A may vary an output mode of information (an image or a voice) provided to the second device 200 in accordance with the type or the information amount of information which can be provided and on which the availability setting is performed by the user U, or may provide the second device 200 with advertisement information in accordance with the type or the information amount of the information. Further, the provision portion 330A may perform notification to the occupant P from the user U before the information acquired from the first device 100 is provided to the second device 200.

According to the modification example described above, the management server 300A can unify the management of the image and the voice that are provided. Thereby, it is possible to more accurately know the type, the data amount, and the provision time of the provided information, and it is possible to appropriately manage a service usage fee and the like. Accordingly, for example, the provision portion 330A may provide the first device 100 or the second device 200 with advertisement information in accordance with the type or the information amount of provided information, for example, from among advertisement information registered in the provision information DB 362, and may cause the fee management portion 340 to perform adjustment of the fee such as reducing the usage fee of the simulation boarding service or paying the compensation in accordance with the number of times of viewing the advertisement by the occupant P or the user U, the viewing time, or the like. The advertisement information may be information relating to the movable body M, or when the occupant P or the user U is a famous person, the advertisement information may be information relating to the person. Further, as shown in the modification example, by performing image editing, display control, and the like on the management server 300A side, it is possible to reduce a process load of the first device 100 and the second device 200.

### SUMMARY

According to the information processing system 1 having a configuration described above, it is possible to enhance a sense of presence given to a user U who is at a different place from a movable body M. Further, according to the embodiment, it is possible to improve the visibility of the user and the safety of an occupant, further improve the safety of the traffic, and contribute to the development of a sustainable transportation system. In the embodiment, since a sound in which the sound volume ratio of the vehicle inside sound and the vehicle outside sound is adjusted in accordance with motion of the user is output to the user U, the user U can hear a sound accompanying the travel of the movable body M as if the user U is in the passenger seat S2. Further, since an image corresponding to the pointing direction φ of the user U seen from the passenger seat is displayed, the user U can visually recognize the surrounding landscape linked to the sound accompanying the travel of the movable body M. Further, since an image indicating the sound volume ratio of the vehicle inside sound and the vehicle outside sound is displayed on the movable body image display device 250, the user U can know the sound volume ratio. Further, the user U can set a first posture corresponding to a posture of being at the room inside and a second posture corresponding to a posture of being at the room outside in advance. Accordingly, even a user who has difficulty in standing up due to physical characteristics can hear the sound in which the vehicle inside sound and the vehicle outside sound are adjusted in accordance with the motion of the user, and it is possible to enhance a sense of presence of the simulation boarding.

### Use Example

The information processing system 1 can be used in the following mode.
(A) A mode in which the occupant P and the user U are in a relationship such as a family or a friend, and a virtual drive is provided to the user U. The user U can hear the sound of the vehicle inside and the vehicle outside relating to the travel of the movable body M and can talk with the occupant P.
(B) A mode in which the occupant P is a general user, and the user U is a provider of a route guidance service, a driving instruction service, or the like. The user U can perform instruction of a driving operation based on the travel situation of another vehicle or the like such as the timing of using the turn signal while listening to the sound in the vicinity of the movable body M.
(C) A mode in which the occupant P is a famous person, the user U is a general user, and a virtual drive on a commercial basis is provided to the user U. In this case, a plurality of users U may be simultaneously associated with one occupant P, and, for example, the transfer of a voice from the user U side may be set to OFF. Further, the user U may pay an additional fee, and thereby, conversation with the occupant P for a predetermined time may become possible.

Although modes for implementing the present invention have been described using the embodiment, the present invention is not limited to such an embodiment at all, and various modifications and replacements can be made without departing from the scope of the present invention.

What is claimed is:

1. An information management apparatus that manages information acquired from a first device mounted on a movable body on which an occupant boards and provided to a second device used by a user at a different place from the movable body, the information management apparatus comprising:
an acquisition portion that acquires information from the first device and the second device; and
a provision portion that provides information to each second device based on the information acquired by the acquisition portion,
wherein the acquisition portion acquires a first sound at a first position of the movable body and a second sound at a second position that is different from the first position by the first device and acquires motion information of the user by the second device, and
the provision portion provides the second device with a sound in which a sound volume ratio of the first sound and the second sound is adjusted in accordance with a motion of the user.

2. The information management apparatus according to claim 1,
wherein the first sound is a sound collected at a room inside of the movable body,
the second sound is a sound collected at a room outside of the movable body, and
the provision portion
provides the second device with a sound in which a sound volume of the second sound is smaller than that of the first sound in response to the user being in a first posture corresponding to a posture of being at the room inside of the movable body and
provides the second device with a sound in which the sound volume of the second sound is larger than that of the first sound in response to the user performing a motion of becoming a second posture corresponding to a posture of being at the room outside of the movable body from the first posture.

3. The information management apparatus according to claim 2,
wherein the first posture is a seated posture, and
the second posture is a standing posture.

4. The information management apparatus according to claim 2,
wherein the first posture is a posture of facing a travel direction of the movable body in a seated state, and
the second posture is a posture of facing a direction that is orthogonal to the travel direction of the movable body in the seated state.

5. The information management apparatus according to claim 2,
wherein the first posture is a posture of seeing a travel direction of the movable body, and
the second posture is a posture of seeing a direction that is orthogonal to the travel direction of the movable body.

6. The information management apparatus according to claim 1,
wherein the first sound is a sound at a room inside of the movable body,
the second sound is a sound at a room outside of the movable body,
the provision portion provides the second device with a sound in which a sound volume of the second sound is smaller than that of the first sound when a window of the movable body is in a closed state, and
the provision portion provides the second device with a sound in which a sound volume of the second sound is larger than that of the first sound in response to the user performing a motion of opening the window of the movable body.

7. The information management apparatus according to claim 2,
wherein the acquisition portion acquires a room inside image and a room outside image of the movable body by the first device, and
the provision portion
provides the second device with the room inside image in response to the user being in the first posture and
provides the second device with the room outside image in response to the user performing a motion of becoming the second posture from the first posture.

8. The information management apparatus according to claim 1,
wherein the provision portion provides the second device with an image indicating the sound volume ratio of the first sound and the second sound.

9. An information management method comprising:
by way of a computer of an information management apparatus that manages information acquired from a first device mounted on a movable body on which an occupant boards and provided to a second device used by a user at a different place from the movable body,
acquiring information from the first device and the second device;
providing information to each second device based on the acquired information;
acquiring a first sound at a first position of the movable body and a second sound at a second position that is different from the first position by the first device;
acquiring motion information of the user by the second device; and
providing the second device with a sound in which a sound volume ratio of the first sound and the second sound is adjusted in accordance with a motion of the user.

10. A computer-readable non-transitory storage medium storing a program which causes a computer of an information management apparatus that manages information acquired from a first device mounted on a movable body on which an occupant boards and provided to a second device used by a user at a different place from the movable body to:
acquire information from the first device and the second device;
provide information to each second device based on the acquired information;
acquire a first sound at a first position of the movable body and a second sound at a second position that is different from the first position by the first device;
acquire motion information of the user by the second device; and
provide the second device with a sound in which a sound volume ratio of the first sound and the second sound is adjusted in accordance with a motion of the user.
